(19) United States
(12) Patent Application Publication
(10) Pub. No.: US 2021/0399386 A1
(43) Pub. Date: Dec. 23, 2021

(54) CELL CONNECTOR FOR ELECTRIC-CONDUCTIVELY CONNECTING ROUND CELLS OF A BATTERY FOR A MOTOR VEHICLE, AND METHOD FOR PRODUCING A BATTERY FOR A MOTOR VEHICLE

(71) Applicant: LISA DRÄXLMAIER GMBH, Vilsbiburg (DE)

(72) Inventors: Peter FALTERMEIER, Landshut (DE); Alexander HAHN, Rottenbach (DE); MIchael STECKEL, Vilsbiburg (DE)

(21) Appl. No.: 17/291,333

(22) PCT Filed: Nov. 6, 2018
(86) PCT No.: PCT/EP2018/080371

§ 371 Date: May 5, 2021

(51) Int. Cl. H01M 50/502; H01M 50/213; H01M 50/56

(52) U.S. Cl. CPC H01M 50/502; H01M 2220/20; H01M 50/56; H01M 50/213

(57) ABSTRACT

A cell connector for electric-conductively connecting round cells of a battery for a motor vehicle is disclosed. The cell connector includes a plurality of electric-conductive contact elements for connecting two each of the round cells in series connection on the face side. The contact elements are each provided with a floor-side or bottom contact surface for producing an integral connection to a respective cell cap of the round cells, and spring arms for producing a force-fit connection to a respective cell cup of the round cells; a plurality of electric-conductive connection webs which connect the contact elements arranged in groups with one another. The contact elements and the connection webs are produced from a common punch-bent part. A method for producing a battery for a motor vehicle is also disclosed.

### CROSS REFERENCE TO RELATED APPLICATIONS

This application is a national phase application of International Application PCT/EP2018/080371, filed on Nov. 6, 2018, the content of which is hereby incorporated herein by reference

### BACKGROUND OF THE INVENTION

The present disclosure relates to a cell connector for electrically and conductively connecting round cells of a battery for a motor vehicle and to a method for producing a battery for a motor vehicle. Furthermore, the present disclosure relates to a battery for a motor vehicle, comprising a plurality of round cells which are electrically and conductively connected to one another by means of at least one cell connector.

To be able to provide required electrical energy for electrically driven motor vehicles, whether they be hybrid vehicles or solely electrically driven motor vehicles, a plurality of individual battery cells are usually connected or interconnected to each other in an electrically conductive manner. In particular, the assembly and interconnection of such battery cells can be very complex. The individual battery cells are usually—depending on the power requirement—connected in different configurations partly in parallel and partly in series. In order to be able to supply high-voltage systems of electrically driven motor vehicles with a corresponding voltage, it is usually necessary to partially interconnect such battery cells in series, for example, to achieve 400 volts or more. Several cells may also be connected in parallel to increase capacity. A major challenge in the manufacture of such batteries for motor vehicles is to ensure that the individual battery cells make electrical contact with each other as simply and reliably as possible.

Granted European patent EP 3 096 372 B1 describes electrical and conductive connections for several round cells of a battery. The round cells are connected to a battery module by means of a plastic base plate in a defined arrangement. In addition, a parallel plate made of an electrically and highly conductive contact material is used for an electrically conductive connection of the round cells. A contact spring is welded onto the parallel plate for each round cell. The contact springs are permanently connected to a respective positive pole of the corresponding round cell by means of a laser welding method. The contact springs are each shaped in such a way that they provide a receiving unit for another round cell positioned above them via spring arms. In particular, welding the contact springs to the base plate is very complex. In addition, difficulties can arise with the exact positioning of the individual contact springs.

### BRIEF SUMMARY OF THE INVENTION

An object of the present disclosure is to provide a solution by means of which a plurality of round cells of a battery for a motor vehicle can be electrically and conductively connected in a particularly simple and reliable manner.

This and other objects are solved by a cell connector for electric-conductively connecting round cells and by a method for producing a battery for a motor vehicle having the features of the independent patent claims. Advantageous embodiments with expedient and non-trivial embodiments of the invention are set out in the dependent claims.

The cell connector according to the present disclosure for electric-conductively connecting round cells of a battery for a motor vehicle comprises a plurality of electrically conductive contact elements for connecting two of the round cells in series on the front side, the contact elements each having a floor-side contact surface for producing a bonded connection to a respective cell cap of the round cells and spring arms for producing a frictional or non-positive or force locking connection to a respective cell cup of the round cells. The cell cap can be a respective positive pole and the cell cup a respective negative pole of the round cells. However, it is also possible for the cell cap to be a respective negative pole and for the cell cup to be a respective positive pole of the round cells, although this is in and of itself rather unusual. In addition, the cell connector according to the present disclosure comprises a plurality of electrically conductive connecting webs which interconnect the contact elements arranged in groups. The contact elements and connecting webs are thereby made from a common punch-bent part. For example, the contact elements and connecting webs can be made from a single metal sheet. The cell connector according to the present disclosure therefore does not have to be produced in a complex manner by welding the contact elements and the connecting webs. The fact that the contact elements and the connecting webs are made from a common punch-bent part means that the entire cell connector can be produced in large quantities in a particularly simple and cost-effective manner.

In order to connect a respective pair of round cells in series with each other, only the floor-side or bottom side contact surface of one of the contact elements must be bonded to a respective cell cap of the round cells, for example by laser welding or the like. A further round cell with its cell cup can then simply be inserted between the spring arms, as a result of which the cell cup of the round cell, for example the negative pole of the round cell, is held in a frictionally manner between the spring arms. In this way, individual round cells can be easily contacted or interconnected in series in pairs by means of the cell connector. By means of the electrically conductive connecting webs, which in turn electrically conductively connect the contact elements which are arranged in a row, for example, also allow several round cells arranged next to each other to be connected in parallel in a simple and reliable manner or electrically conductively connected to each other. The common punch-bent part from which the contact elements and the connecting webs are produced is preferably punched out of an electrically conductive material and shaped accordingly in order to achieve the shaping of the individual contact elements. The material of the punch-bent part is preferably selected in such a way that it meets both requirements with regard to good electrical conductivity and with regard to mechanical requirements, in particular with regard to high tensile strengths and low thermal stress relaxation.

By means of the cell connector according to the present disclosure, it is possible in a particularly simple and reliable manner to contact a plurality of round cells of a battery for a motor vehicle both in series and in parallel with one another. Since the punch-bent part, from which the contact elements and the connecting web are produced, preferably comprises an individual sheet metal, the cell connector can be handled particularly easily during battery assembly, especially when contacting the individual round cells. In addition, a position-accurate arrangement of the contact elements relative to one another is automatically ensured.

According to an embodiment of the present disclosure, a voltage tap for balancing the round cells is formed on one of the externally arranged contact elements. The voltage tap can be designed, for example, in the form of a contact lug or the like, such that a voltage tap can be easily made on the parallel-connected round cells for cell balancing during operation of the battery. For the so-called balancing, the voltages of each round cell or each cell packet connected in parallel must usually be monitored. To avoid having to monitor each round cell of a cell packet individually, the parallel connected round cells are monitored among each other via the voltage tap.

A further embodiment of the present disclosure provides that each of the spring arms have at least one stiffening bead. The entire current of the respective round cells flows through the finger-like spring arms, which is why the material should have good conductivity, for example, by comprising copper or the like. The volume of the spring arms should be as large as possible to have a low electrical resistance. The spring force of the individual spring arms should be very large to minimize the contact or transition resistance. For the latter requirement, it would be particularly advantageous if the spring arms were made of spring steel, for example. If the stress relaxation is high, the contact element loses its contact pressure over time, so that the resistance increases. In this case, the contact elements could be thermally destroyed by the increased load. The current in combination with the sum of the resistances results in a power loss which is no longer available to a drive of the motor vehicle in question and which is converted into heat which also has to be dissipated. A particularly large current per round cell flows in so-called boost batteries. The number, volume and conductivity of the spring arms of the contact elements should be maximized and the contact resistance minimized. Copper, for example, is a very good electrical conductor, but has a rather low tensile strength and a high stress relaxation. A sufficient contact pressure through the spring arms can be achieved by increasing the spring force by additional, skillful shaping of the material in the area of the spring arms. This effect can be achieved particularly easily and reliably by means of the stiffening beads in the spring arms. The stiffening beads are preferably formed starting from the floor-side contact surface into the spring arms. This increases the bending stiffness or rigidity of the spring arms and increases the spring force of the spring arms. This further ensures a permanently reliable electrical contact between the spring arms of the contact elements and the respective cell cups of the round cells.

According to a further embodiment of the invention, the spring arms have at least one longitudinal slot in order to favor a flat fitting to the respective lateral surfaces of the cell cups of the round cells. Depending on the geometry and size, the spring arms can also have several of these longitudinal slots, so that the spring arms are divided into individual segments, which can fit particularly well on the respective lateral surfaces of the cell cups of the round cells. The respective contact resistance between the spring arms of the contact elements and the respective round cells can thus be reduced.

In a further embodiment of the present disclosure, the floor-side contact surface of the contact elements is raised. In this case, raised means that the bottom contact surfaces are raised in the opposite direction to the direction in which the spring arms extend. The contact elements can be connected to the respective cell caps of the round cells in a particularly simple and reliable manner, for example by laser welding or the like. In addition, this results in a certain spatial isolation distance between floor-side contact surface and the spring arms, by means of which the respective cell cups can be held.

A further embodiment of the present disclosure provides for a respective spring ring, preferably made of a spring steel, surrounding the spring arms of the respective contact elements on the outer circumference. The contact elements themselves, in particular the spring arms, can thus be made of a particularly well electrically conductive material, such as copper. The spring ring, which surrounds the spring arms of the respective contact elements on the outer circumference, can nevertheless ensure a sufficiently good spring force and thus a sufficiently good frictional or non-positive or force locking connection between the respective cell cup of the round cells and the contact elements.

According to a further embodiment of the invention, the stamped bent part is made from a first sheet metal and from a second sheet metal, which are connected to one another arranged one above the other, wherein the first sheet has a better electrical conductivity than the second sheet and the second sheet has a higher spring stiffness, in particular also a lower stress relaxation, than the first sheet. This hybrid design of the punch-bent part allows both the mechanical requirements and the requirements with regard to electrical conductivity to be met equally well. The two sheets of the different materials can be produced, for example, by cold rolling. Due to the hybrid design of the punch-bent part, the electrical conductivity of the contact elements can be maximized on the one hand and a permanently applied frictional or non-positive or force locking connection between the contact elements and the round cells can be ensured on the other.

A further embodiment of the present disclosure provides that the contact elements are arranged in a plurality of rows and columns with respect to one another and that the contact elements, each of which is directly adjacent, are connected to one another by means of one of the connecting webs. For some traction batteries for electrically driven motor vehicles, a large capacity is particularly desired. For this purpose, many round cells per battery module are usually connected in parallel or electrically conductively connected to each other. As the cell connector can have the contact elements arranged in several rows and columns relative to one another, it is possible in a simple manner by means of the embodiment of the cell connector, to connect a plurality of round cells not only in series but also in parallel with each other in order to provide, in particular, a battery with a very high capacity. For batteries with larger capacities, the round cells used usually have a high capacity but with very low currents. In this case, the contact resistance and the specific resistance play a rather minor role. In this case, it is possible to provide a small number of spring arms per contact element, for example only three spring arms. In this way, it is possible in a particularly simple manner to manufacture the punch-bent part from which the contact elements and connecting webs are made, for example, from a single continuous sheet metal.

According to another embodiment of the present disclosure, the connecting webs have respective beads for compensating mechanical stresses. Due to temperature fluctuations and different material coefficients within the battery, the respective materials can expand differently. This could lead to stresses and, under certain circumstances, to fatigue fractures or similar, in particular at the respective cohesive connections between the contact elements and the cell caps of the round cells. In order to prevent this, it is preferably provided that the beads are provided on the connecting webs in order to compensate for mechanical stresses. In this way, possible mechanical stresses can be compensated, especially in all spatial directions. This ensures permanently reliable contact or electrical connection of the individual round cells within the battery.

The battery for a motor vehicle according to the present disclosure comprises a plurality of round cells which are electrically conductively connected to one another by means of at least one cell connector according to the invention or at least one advantageous embodiment of the cell connector according to the invention.

According to one embodiment of the battery, the battery comprises a plurality of battery modules arranged one behind the other, each of which has a module housing with respective through-openings enclosing the round cells, wherein at least one of the cell connectors is arranged between the respective facing end faces of the module housings, by means of which the round cells arranged in the respective module housings are electrically conductively connected to one another. In this way, the battery can be assembled from the individual battery modules in a particularly simple manner. The cell connectors serve as electrically conductive interfaces between the individual battery modules, that is, between the individual cells of the respective battery modules, and also as electrical connection points or interfaces within the battery modules themselves.

A further embodiment of the battery provides that the module housings each have an insulator with recesses for respective cell caps of the round cells, on which the cell connectors are arranged and, with their raised floor-side contact surface, are connected to the cell caps of the round cells which are arranged in the insulator in a recessed manner. If the individual battery modules are not inserted exactly into each other during production or, for example, individual spring arms of the contact elements are bent, this could lead to a short circuit in one or more round cells. This short circuit could cause a thermal runaway, which could affect neighboring cells. Preferably, the insulator is provided, which is arranged between the respective cell cups of the round cells, for example the negative poles, and the individual contact elements. The insulator can, for example, be a plastic disc or a perforated plate. As the module housings preferably comprise the insulator themselves, the insulator does not have to be mounted within the battery in a time-consuming manner. A further advantage of the module housing, including the respective insulator, is that the round cells can be positioned in the longitudinal direction in an optimal and tolerance-free manner with respect to each other. Preferably, the cutouts of the insulator have a smaller diameter than the round cells, such that an axial stop for the respective round cells is automatically provided by the cutouts.

In the method for producing a battery for a motor vehicle, a plurality of round cells are electrically conductively connected to one another by means of at least one cell connector according to the invention or by means of an embodiment of the cell connector according to the invention.

An embodiment of the method provides that the battery is composed of a plurality of battery modules, wherein the battery modules are produced, in that several of the round cells are arranged in respective through-openings of a respective module housing for each battery module and respective cell caps of the round cells are bonded to at least one of the cell connectors for each module housing. First, the respective contact elements with their floor-side contact surface are connected to the respective cell caps of the round cells, for example by means of laser welding.

For this purpose, the round cells must be fixed in the correct position relative to each other. This could be done, for example, by a workpiece carrier or the like, but preferably this is done by the respective module housings themselves, which have the through-openings for enclosing the round cells. Before the cell caps of the round cells are bonded to the contact elements, the round cells are first inserted or positioned in the through-openings of the respective module housing. Another advantage is that the module housings themselves can also serve as transport containers for the round cells from a cell manufacturer to a battery manufacturer. Suitable devices on the module housings preferably fix the cell connectors at their respective intended position, so that the connection of the individual contact elements to the respective cell caps of the round cells is significantly simplified and can be carried out by machine.

Finally, a further embodiment of the method provides that the produced battery modules are plugged together one behind the other and respective cell cups of the round cells are plugged between the respective spring arms of the contact elements on the respective adjacent battery modules. After inserting the round cells into the respective module housing and welding the contact elements with their floor-side contact surface on the cell caps of the round cells, the respective cell cups of the round cells, that is the cup bases, of the next round cells between the spring arms of the respective contact elements. For this step, the corresponding round cells also have to be fixed. This in turn could be done by a workpiece carrier, but preferably by the respective module housings, in which the round cells are already fixed. In principle, two complete battery modules are inserted into each other. In order to produce a battery, several of the battery modules can also be connected one after the other. The respective contact elements can also be used to equalize the length of the individual round cells.

Further advantages, features and details of the invention result from the following description of preferred embodiments and from the drawing. The features and combination of features mentioned above in the description as well as the features and combination of features mentioned below in the figure description and/or shown in the figures alone are not only in the respectively specified combination, but can also be used in other combinations or in a unique position without leaving the scope of the invention.

### BRIEF DESCRIPTION OF THE SEVERAL VIEWS OF THE DRAWINGS

Further advantageous features and details of the various embodiments of this disclosure will become apparent from the ensuing description of a preferred exemplary embodiment and with the aid of the drawings. The features and combinations of features recited below in the description, as well as the features and feature combination shown after that in the drawing description or in the drawings alone, may be used not only in the particular combination received, but also in other combinations on their own, without department from the scope of the disclosure.

In the following, advantageous examples of the invention are explained with reference to the accompanying figures, wherein:

FIG. 1 depicts a perspective view of a partially represented battery for a motor vehicle, comprising a plurality of battery modules plugged into each other, each having a plurality of round cells;

FIG. 2 depicts a perspective view of three round cells, which are connected by means of a cell connector;

FIG. 3 depicts a perspective view of one of the round cells;

FIG. 4 depicts a perspective view of one of the cell connectors installed in the battery, which has a plurality of electrically conductive contact elements which are connected to one another by respective electrically conductive connecting webs;

FIG. 5 depicts a perspective view of a plurality of round cells, three pairs of round cells being connected to each other in series by means of one of the cell connectors on the front face;

FIG. 6 depicts a sequence of steps for manufacturing the individual battery modules;

FIG. 7 depicts a perspective view of two battery modules before they are plugged together;

FIG. 8 depicts a perspective view of detail on one of the battery modules before the cell connectors are attached to the battery module;

FIG. 9 depicts another perspective view of detail on one of the battery modules after the cell connectors are attached;

FIG. 10 depicts a perspective view of a further embodiment of the cell connector, the cell connector comprising several spring rings per contact element;

FIG. 11 depicts a top view of the further embodiment of the cell connector;

FIG. 12 depicts a sectional view of the further embodiment of the cell connector along the sectional plane A-A indicated in FIG. 11;

FIG. 13 depicts a perspective view of a partially completed punch-bent part from which the contact elements and connecting webs are produced; and

FIG. 14 depicts a perspective view of a further embodiment of the cell connector, which has been manufactured from the punch-bent part shown in FIG. 13.

### DETAILED DESCRIPTION OF THE INVENTION

As used throughout the present disclosure, unless specifically stated otherwise, the term “or” encompasses all possible combinations, except where infeasible. For example, the expression “A or B” shall mean A alone, B alone, or A and B together. If it is stated that a component includes “A, B, or C”, then, unless specifically stated otherwise or infeasible, the component may include A, or B, or C, or A and B, or A and C, or B and C, or A and B and C. Expressions such as “at least one of” do not necessarily modify an entirety of the following list and do not necessarily modify each member of the list, such that “at least one of “A, B, and C” should be understood as including only one of A, only one of B, only one of C, or any combination of A, B, and C.

In the figures, identical or functionally identical elements have been provided with the same reference signs.

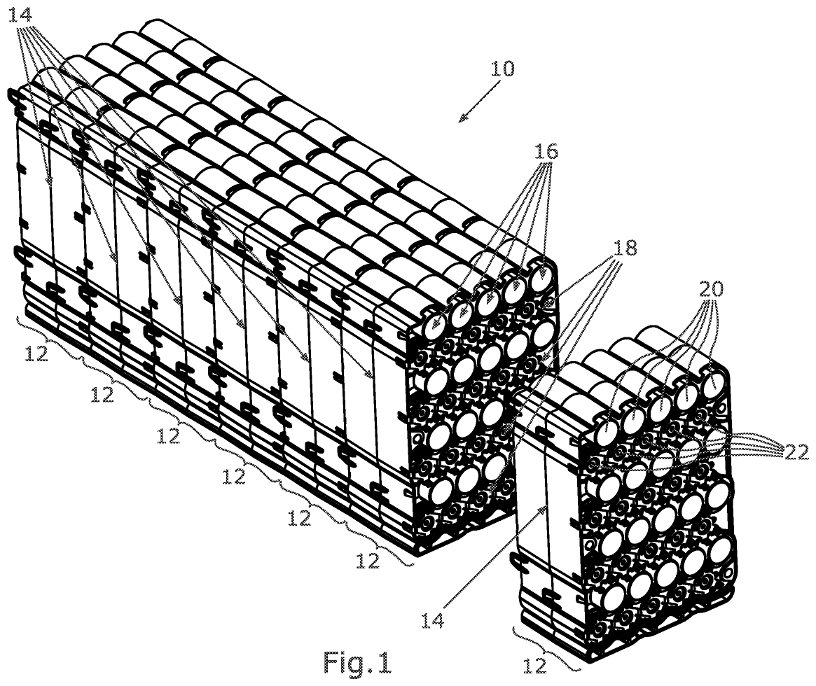

A battery 10 for a motor vehicle is partially shown in a perspective view in FIG. 1. Battery 10 can, for example, be a high-voltage battery for an electrically driven motor vehicle. The battery 10 is made of a plurality of battery modules 12 inserted into each other. Each battery module 12 comprises a respective module housing 14, which are designed in such a way that the module housing 14 can be plugged into each other.

Each of the battery modules 12 comprises a plurality of round cells 16, wherein only some of the round cells 16 have been provided with a reference sign for clarity. In the example shown here, each of the battery modules 12 has eight, unspecified cell packets of five of the round cells 16, arranged one above the other. The respective cell connectors 18 are used for electrically conductive connection of the individual round cells 16 across modules. By means of the cell connector 18, respective cell cups—in this case respective cell cup 20—and cell caps—in this case respective cell cap 22—of the round cells 16 can be electrically conductively connected to each other across modules. Although it is always assumed that the cell caps are the respective positive pole 22 and the cell cups are the respective negative pole 20, the following explanations apply equally to the opposite case; i.e. if the positive and negative poles are reversed.

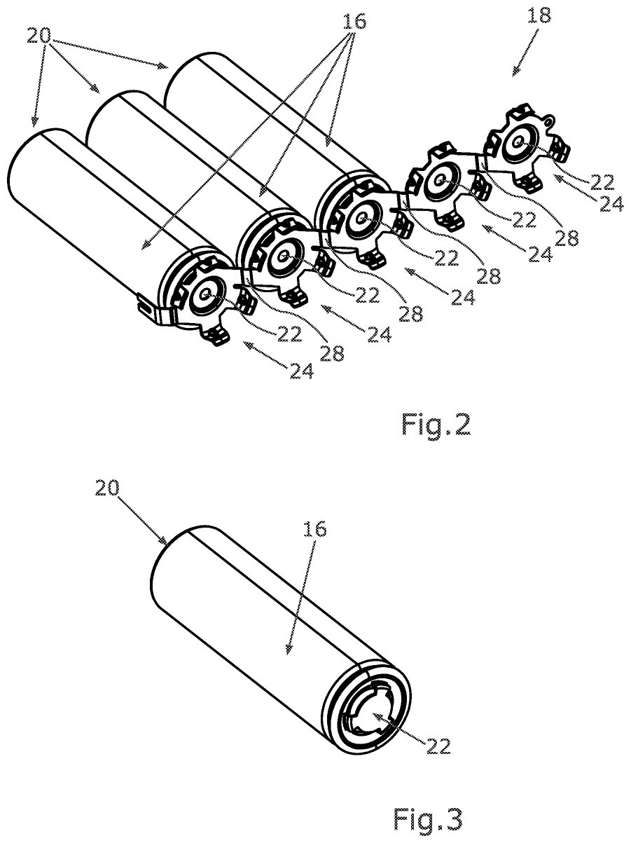

In FIG. 2, three of the round cells 16 are shown in a perspective view, which are connected or contacted to each other in parallel by means of one of the cell connectors 18. The cell connector 18—and also the other cell connectors 18 of the battery 10—have electrically conductive contact elements 24 for pairwise end-side connection of two of the round cells 16 in series. The contact elements 24 also have a respective floor-side contact surface not specified here for producing a bonded connection to the positive pole 22 of the round cells 16. In addition, the contact elements 24 in the case shown here each have four spring arms 26 for producing a frictional or non-positive or force locking connection to a respective negative pole 20 of the round cells 16, that is to say to the so-called cup. For the sake of clarity, the individual spring arms 26 have only been provided with a reference sign on the entire left-hand contact element 24. The cell connector 18 further comprises a plurality of electrically conductive connecting webs 28, which connect the contact elements 24 arranged in a row to one another. The connecting webs 28 provide a parallel connection of the respective round cells 16. The contact elements 24 and the connecting webs 28 are produced from a common punch-bent part.

FIG. 3 depicts one of the round cells 16 in a perspective view. In the present representation, the positive pole 22 of the round cell 16 is clearly visible, which can be bonded to one of the the floor-side contact surfaces of the contact elements 24, for example by laser welding or the like.

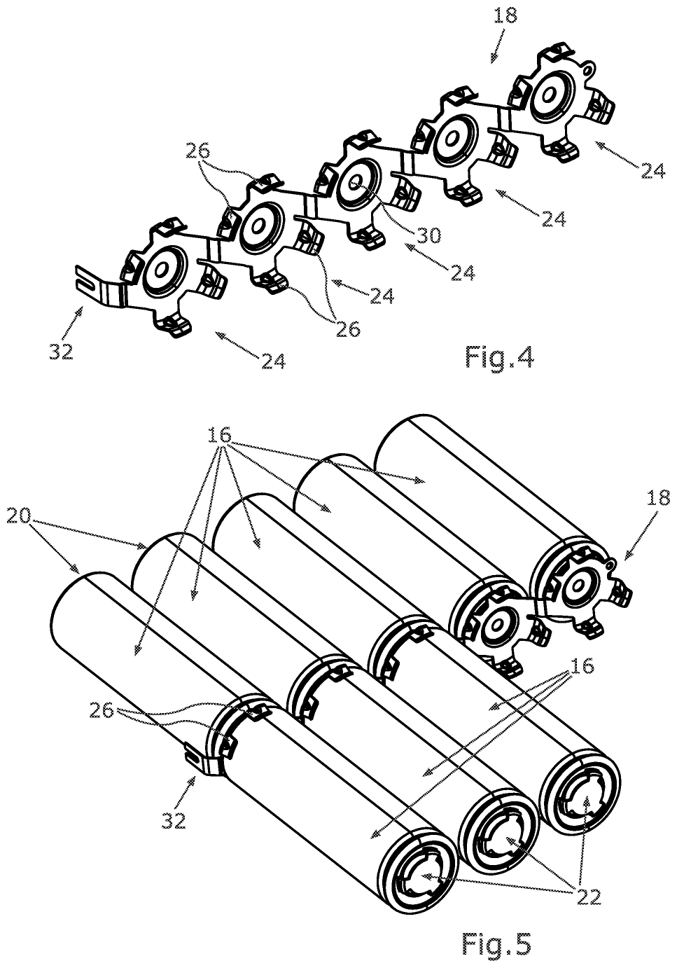

FIG. 4 depicts one of the cell connectors 18 alone in another perspective view. In the present representation, respective holes 30 are to be recognized in the region of the floor-side contact surfaces of the contact elements 24, which are also not specified here. These holes 30 can favor a cohesive connection between the contact elements 24 and the positive pole 22 of the round cells 16 and also contribute to a weight reduction of the cell connectors 18 through material savings.

A voltage tap 32 for balancing the round cells 16 connected in parallel by means of the cell connector 18 is provided at one of the externally arranged contact elements 24, according to the present embodiment on the very left-hand side of the contact element 24. For balancing, the voltages of round cells 16 or each parallel-connected cell packet on round cells 16 per cell connector 18 must be monitored. Via the voltage tap 32, it is not necessary to monitor each of the round cells 16 connected in parallel by means of the cell connector 18 individually with regard to their voltage.

In FIG. 5, eight of the round cells 16 are shown in a perspective view, which have been electrically conductively connected to each other by means of one of the cell connectors 18. In the present embodiment, three pairs of round cells 16 have each been electrically conductively connected to one another by means of the contact elements 24 on the front face. The positive pole 22 of the round cells 16 was electrically conductively connected to a respective negative pole 20 of the round cells 16 by means of the contact elements 24. The respective spring arms 26 establish a frictional or non-positive or force locking connection to the respective negative poles 20 of the respective round cells 16. The round cells 16 must simply be pressed between the respective spring arms 26 of the contact elements 24 with their cell bottom, i.e., with their negative pole 20. The spring arms 26 expand outwards to a certain extent and then enclose the round cells 16 in the area of the negative poles 20 in a non-positive manner, as a result of which reliable electrical contacting can be ensured.

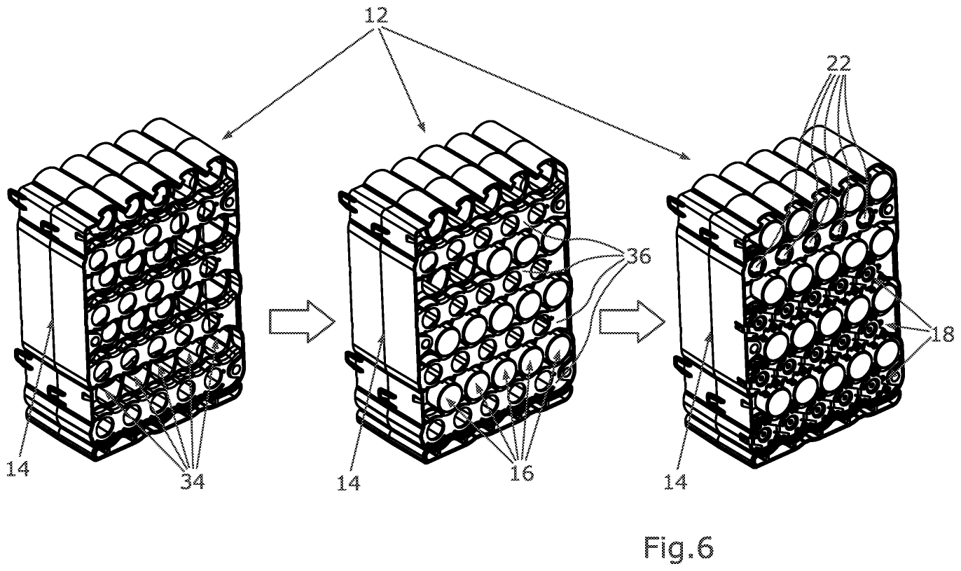

In FIG. 6, one of the battery modules 12 is shown three times to explain individual steps for producing the battery modules 12. The module housings 14 of the battery modules 12 have respective cylindrical through-openings 34 for each of the round cells to be accommodated and enclosed by the round cells 16. As already mentioned, the battery modules 12 have eight rows of five round cells 16 arranged one above the other. The round cells 16 are arranged alternately once with their positive pole 22 forwards or with their negative pole 20 forwards. The respective module housings 14 are therefore equipped with the individual round cells 16. In addition, the module housings 14 have respective insulators 36 for each cell row, wherein the insulators are likewise arranged alternately either on the front side or on the rear side on the module housings 14 as a component of the module housings 14, in accordance with the arrangement of the round cells 16. According to the alternating arrangement of the round cells 16 with their negative poles 20 and positive poles 22 to the front side or to the rear side, the individual cell connectors 18 are arranged.

After the individual round cells 16 have been arranged in the module housings 14, more precisely in the through-openings 34, the individual positive poles 22 are bonded to the cell connectors 18, for example by laser welding. As a result of the fact that the round cells 16 are arranged within the through-openings 34, they are reliably and precisely fixed in position. In addition, further devices can be provided on the module housings 14 in order to fix the round cells 16 in the correct position for the welding process, so that the connection of the contact elements 24 of the respective cell connectors 18 to the positive poles 22 is significantly simplified and can be carried out mechanically.

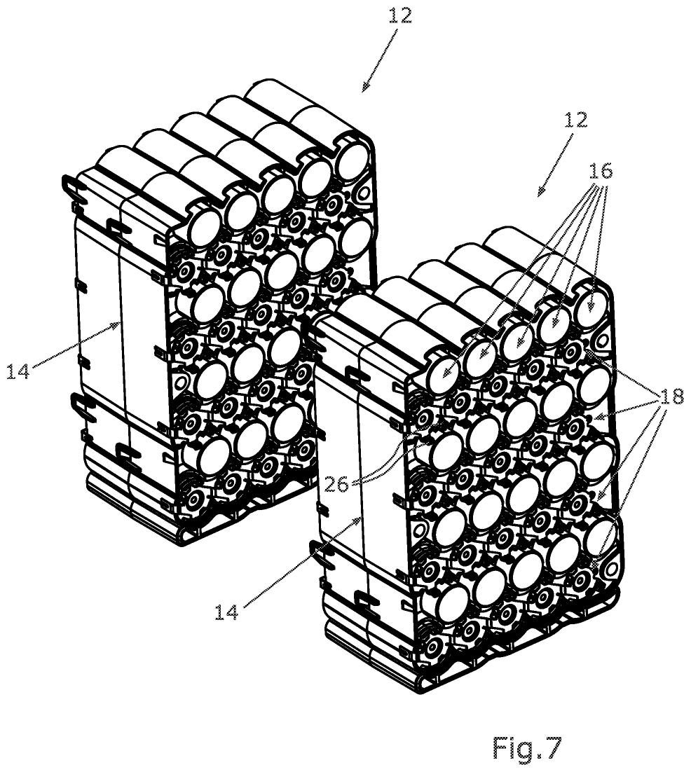

After inserting the individual round cells 16 into the module housing 14 and welding the contact elements 24 to the positive poles 22, the individual battery modules 12 can be plugged into each other. In FIG. 7, this process is illustrated by two battery modules 12 depicted in perspective and equipped with round cells 16. The two battery modules 12 with the fitted round cells 16, which have already been bonded to the respective cell connectors 18 with their respective positive poles 22, are simply plugged together. The respective negative poles 20 of the round cells 16 are inserted between the respective spring arms 26 of the contact elements 24 of the respective cell connector 18, which are arranged on the respectively adjacent battery module 12. The spring arms 26 are bent radially outwards and clasp the respective negative poles 20 of the round cells 16, as a result of which electrical contacting can be ensured. The battery 10 shown in FIG. 1 can then be assembled or manufactured by plugging together several of these pre-assembled battery modules 12.

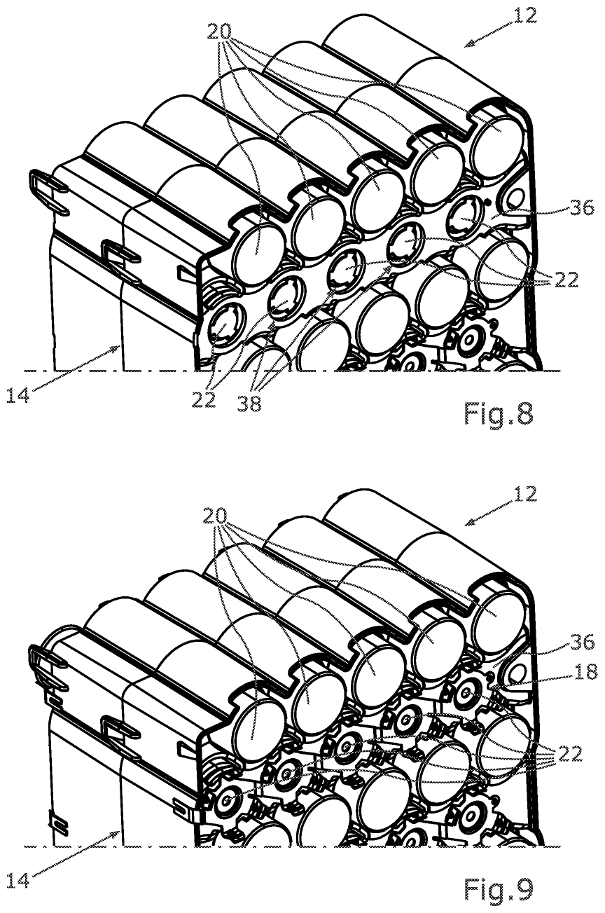

In FIG. 8, one of the battery modules 12 is shown in a perspective detail view, even before the individual cell connectors 18 have been attached. If the battery modules 12 are not inserted exactly into each other or if, for example, one of the spring arms 26 of the cell connectors 18 is bent, this could lead to a short circuit between the individual round cells 16. This short circuit could cause a thermal runaway, which could affect the neighboring cells. In order to prevent this, the insulators 36 are provided as part of the module housings 14. The respective module housings 14 have the insulators 36 per cell row. The insulators 36 have respective recesses 38 for the respective positive poles 22 of the round cells 16. The individual positive poles 22 are arranged set back from the insulators 36, the positive poles 22 do not protrude beyond the respective insulators 36 in the axial direction. The insulators 36 can be plastic discs or perforated plates. A further advantage of the insulators 36 provided with recesses 38 is that the individual round cells 16 can be optimally and tolerance-free positioned in the longitudinal direction, since the diameters of the recesses 38 are smaller than the outer diameters of the round cells 16.

In FIG. 9, the battery module 12 is shown in a further perspective detailed view, whereby the cell connectors 18 have now been attached. The cell connectors 18, with their raised ground/floor-side contact surfaces not specified here, have been connected to the positive poles 22 of the round cells 16, which are arranged in the insulators 36 and are offset backwards. By providing the insulators 36 and the correspondingly recessed arrangement of the positive poles 22 of the round cells 16, short circuits between the individual round cells 16 can be effectively avoided while the battery modules are plugged together.

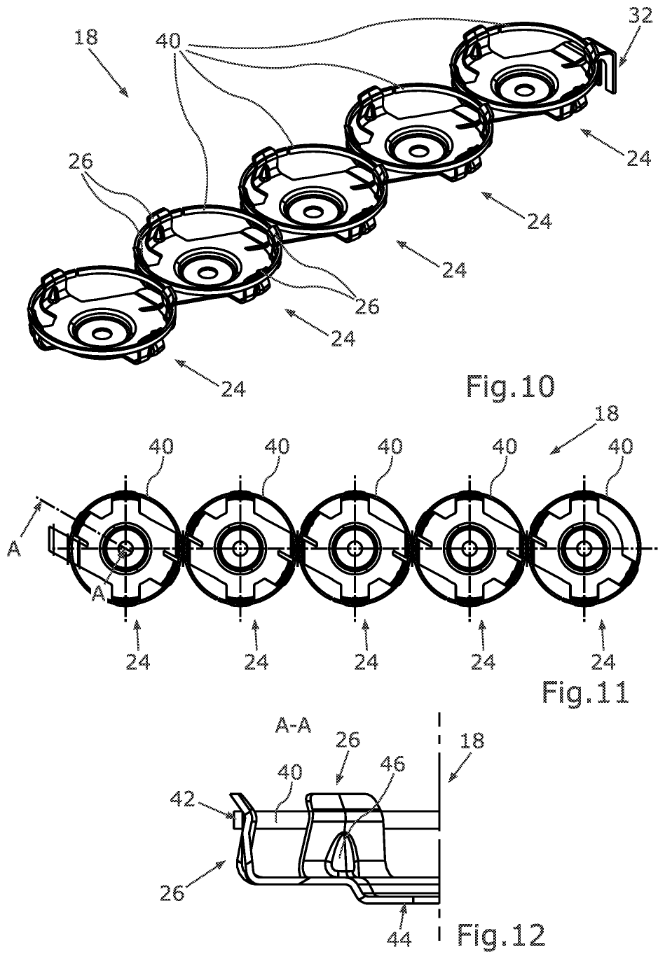

FIG. 10 depicts a further possible embodiment of the cell connector 18 in a perspective view. The cell connector 18 shown here differs from the cell connectors 18 shown above only in that a respective spring ring 40 surrounds the spring arms 26 of the respective contact elements 24 on the outer circumference. In this way, an additional reinforcing spring force can be ensured when the force-locked connection is established with the respective negative poles 20 of the round cells 16. Even if the spring arms 26 have an unfavorable relaxation behavior, the spring rings 40 ensure that the frictional or non-positive or force locking connection to the respective negative poles 20 of the round cells 16 can be maintained permanently and reliably. In this case, for example, it would be possible to produce the cell connector 18 itself from copper, which has very good electrically conductive capabilities, but relatively unfavorable mechanical properties. The latter can be compensated by the spring rings 40, which surround the respective spring arms 26 on the outer circumference. Preferably, the spring ring 40 exerts a certain preload on the respective spring arms 26.

In FIG. 11, the embodiment of the cell connector 18 shown in FIG. 10 is shown in a plan view. Here it is easy to see how the respective spring rings 40 surround the four spring arms 26 of the contact elements 24 on the outer circumference.

In FIG. 12, the cell connector 18 is shown along the sectional plane A-A marked in FIG. 11 in a partially cut view. Here it can be clearly seen how the spring rings 40 surround and span the spring arms 26 on the outer circumference. The spring arms 26 have respective indentations 42, into which the spring rings 40 engage. In order to attach or mount the spring rings 40, the spring arms 26 must simply be bent radially inwards, after which the spring ring 40 is then slipped over the spring arms 26 and arranged in the region of the indentations 42. After that, the spring arms 26 can be snapped radially outwards, as a result of which the respective spring ring 40 remains positioned exactly at the indentations 42.

In the present embodiment, the floor-side or bottom contact surface 44 for producing the bonded connection to the respective positive poles 22 of the round cells 16 can be recognized for the first time. All cell connectors 18 have this floor-side or bottom contact surface 44 per contact element 24. As can be seen, the ground-side/floor-side or bottom contact surface 44 is raised. This means that the respective floor-side or bottom contact surfaces 44 are turned outwards opposite to the alignment of the spring arms 26. This facilitates the bonded connection of the floor-side or bottom contact surfaces 44 to the respective positive poles 22 of the round cells 16.

In order to improve the mechanical properties of the spring arms 26, preferably all embodiments of the cell connector 18 for each spring arm 26 each have at least one of stiffening beads 46. The stiffening beads 46 are used in particular to stiffen the spring arms 26 in the radial direction, i.e. when the spring arms are spread radially outwards by the respective round cells 16. The spring force of the individual spring arms 26 should be as large as possible in order to minimize the contact or transition resistance. These stiffening beads 46 also counteract tension relaxation of the spring arms 26.

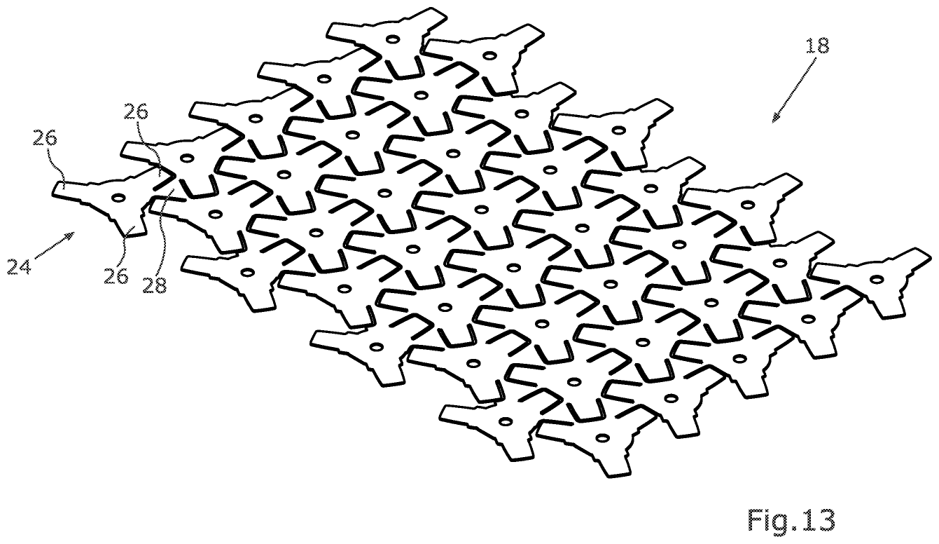

FIG. 13 shows a punch-bent part 48, from which the individual contact elements 24 and connecting webs 28 can be produced. The punch-bent part can, for example, be punched out of a single sheet of metal, wherein the individual spring arms 26 of the contact elements 24 and the corresponding connecting webs 28 are formed. After the punching process, the spring arms 26 are bent upwards, wherein in addition, the respective raised floor-side or bottom contact surfaces 44 can be formed, for example, by a punching process or other forming process.

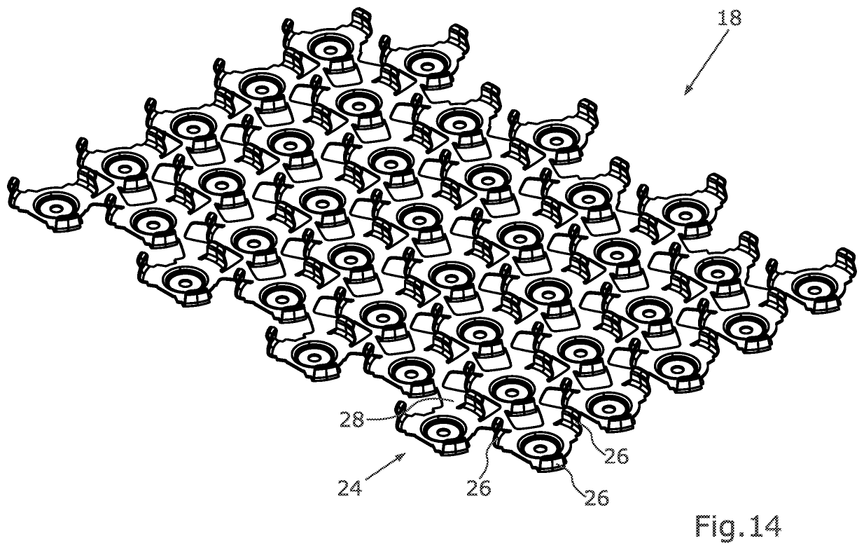

FIG. 14 shows a further embodiment of the cell connector 18 in a perspective view, which is derived from the one in FIG. 13 not yet completed punch-bent part 48. In contrast to the cell connectors 18 shown so far, the cell connector 18 not only comprises a single row of contact elements 24. In addition, the contact elements 24 are arranged in a plurality of rows and columns relative to one another, wherein the contact elements 24, which are each arranged directly adjacent to one another, are connected to one another by means of the respective connecting webs 28. In this case, however, the connecting webs 28 can also have beads for compensating mechanical stresses which are not specified here in the other embodiment.

The cell connector 18 shown here is particularly suitable for batteries with large capacity. Here, many of the round cells 16 per battery module 12 are connected in parallel. Batteries 10 with large capacities usually consist of high-capacity cells, in this case of corresponding round cells 16, with rather low currents per round cell 16. In this case, the contact and the specific resistance play a rather subordinate role. In this case, a lower number of spring arms 26 per contact element 24 is sufficient; in the present case, the contact elements 24 only have three instead of four of the spring arms 26. As only three of the spring arms 26 have to be provided per contact element 24, it is also relatively simple for this embodiment of the cell connector 18 to be produced from a continuous sheet metal by a stamping bending process.

Since the devices and processes described in detail above are exemplary embodiments, they can be modified to a large extent in the usual way by a person skilled in the art without leaving the field of the invention. In particular, the mechanical arrangements and the proportions of the individual elements to each other are simply exemplary. Having described some aspects of the present disclosure in detail, it will be apparent that further modifications and variations are possible without departing from the scope of the disclosure. All matter contained in the above description and shown in the accompanying drawings shall be interpreted as illustrative and not in a limiting sense.

1. A cell connector for electric-conductively connecting round cells of a battery for a motor vehicle, comprising:
a plurality of electrically conductive contact elements configured for connecting two of the round cells in series on the end face, wherein the contact elements each have a bottom contact surface for producing a cohesive connection to a respective cell cap of the round cells and spring arms for producing a force locking connection to a respective cell cup of the round cells; and
a plurality of electrically conductive connecting webs which interconnect the contact elements arranged in groups, wherein the contact elements and connecting webs are produced from a common punch-bent part.

2. A cell connector according to claim 1, further comprising a voltage tap configured for balancing the round cells and formed on one of the externally arranged contact elements.

3. The cell connector according to claim 1, wherein the spring arms each have at least one stiffening bead.

4. The cell connector according to claim 1, wherein the spring arms have at least one longitudinal slot in order to favor a flat fitting to the respective lateral surfaces of the cell cups of the round cells.

5 The cell connector according to claim 1, wherein the bottom contact surfaces of the contact elements are formed raised.

6. The cell connector according to claim 1, further comprising a spring ring arranged to surround the spring arms of the respective contact elements along an outer circumference.

7. The cell connector according to claim 1, further comprising a punch-bent part comprising a first sheet metal and a second sheet metal which are connected to each other and arranged one above the other, wherein the first sheet metal comprises a better electrical conductivity than the second sheet and the second sheet metal comprises at least one of a higher spring stiffness and a lower stress relaxation than the first sheet.

8. The cell connector according to claim 1, wherein the contact elements are arranged in a plurality of rows and columns with respect to one another and the contact elements which are each directly adjacent by means of one of the connecting webs are interconnected.

9. The cell connector according to claim 1, wherein the connecting webs comprise respective beads configured for compensating mechanical stresses.

10. A battery for a motor vehicle, comprising a plurality of round cells electrically conductively connected to one another by means of at least one cell connector, wherein the at least one cell connector includes a plurality of electrically conductive contact elements configured for connecting two of the round cells in series on the end face, wherein the contact elements each have a bottom contact surface for producing a cohesive connection to a respective cell cap of the round cells and spring arms for producing a force locking connection to a respective cell cup of the round cells; and a plurality of electrically conductive connecting webs which interconnect the contact elements arranged in groups, wherein the contact elements and connecting webs are produced from a common punch-bent part.

11. The battery according to claim 10, further comprising a plurality of battery modules arranged one behind the other, each comprising a module housing with respective through-openings enclosing the round cells, wherein at least one of the cell connectors is arranged between the respective facing end faces of the module housings, by means of which the round cells arranged in the respective module housings are electrically conductively connected to each other.

12. The battery according to claim 11, wherein each of the module housings has an insulator with recesses for respective cell caps of the round cells, on which the cell connectors are arranged and raised floor-side contact surfaces connected to the cell caps of the round cells which are arranged in the insulator in a rearranged manner.

13. A method for producing a battery for a motor vehicle, the battery comprising a plurality of round cells are electrically conductively connected to one another by means of at least one cell connector, the method comprising the steps of:
configuring a plurality of electrically conductive contact elements for connecting two of the round cells in series on the end face, wherein the contact elements each have a bottom contact surface for producing a cohesive connection to a respective cell cap of the round cells and spring arms for producing a force locking connection to a respective cell cup of the round cells; and
arranging a plurality of electrically conductive connecting webs to interconnect the contact elements arranged in groups, wherein the contact elements and connecting webs are produced from a common punch-bent part.

14. The method according to claim 13, wherein the battery comprises a plurality of battery modules, wherein the battery modules are produced by several of the round cells in respective through-openings for each battery module of a respective module housing and respective cell caps of the round cells are bonded to at least one of the cell connectors in each module housing.

15. The method according to claim 14, further comprising the steps of:
inserting the battery modules one behind the other; and
arranging cell cups of the round cells between spring arms of the contact elements cell connectors and on the adjacent battery modules.
